(19) United States
(12) Patent Application Publication
(10) Pub. No.: US 2006/0206517 A1
(43) Pub. Date: Sep. 14, 2006

(54) System and method for listing administration

(75) Inventors: Adam Hyder, Los Altos, CA (US); Joseph Ting, San Jose, CA (US)

Correspondence Address: GREENBERG TRAURIG, LLP, MET LIFE BUILDING, 200 PARK AVENUE, NEW YORK, NY, 10166, US

(73) Assignee: YAHOO! Inc., Sunnyvale, CA (US)

(21) Appl. No.: 11/372,528

(22) Filed: Mar. 11, 2006

Related U.S. Application Data
(63) Continuation-in-part of application No. 11/174,393, filed on Jun. 30, 2005.
(63) Continuation-in-part of application No. 11/173,837, filed on Jun. 30, 2005.
(63) Continuation-in-part of application No. 11/173,656, filed on Jun. 30, 2005.
(63) Continuation-in-part of application No. 11/173,470, filed on Jun. 30, 2005.
(60) Provisional application No. 60/661,280, filed on Mar. 11, 2005.

(51) Int. Cl. G06F 7/00; G06F 17/00

(52) U.S. Cl. 707/102

(57) ABSTRACT

A system and method of providing listing data administration to a lister user is disclosed. The listing data is posted on a web search bank hosted by a listing administration provider. Furthermore, the listing data is posted with an assigned hyperlink that references a lister user website hosted by a lister user web server. A selection token is transmitted to the lister web server when an end user selects the assigned hyperlink. An action token is received from the lister web server. The action token can include end user activity data that represents actions performed by the end user at the lister website.

### RELATED APPLICATIONS

This application claims the benefit of priority of U.S. Provisional Patent Application Ser. No. 60/661,280, filed Mar. 11, 2005. This application is a Continuation-In-Part of U.S. patent application Ser. No. 11/174,393, filed on Jun. 30, 2005, entitled SYSTEM AND METHOD FOR MANAGING LISTINGS. This application is also a Continuation-In-Part of U.S. patent application Ser. No. 11/173,837, filed on Jun. 30, 2005, entitled SYSTEM AND METHOD FOR IMPROVED JOB SEEKING. This application is also a Continuation-In-Part of U.S. patent application Ser. No. 11/173,656, filed on Jun. 30, 2005, entitled SEEKING SYSTEM AND METHOD FOR MANAGING JOB LISTINGS. This application is also a Continuation-In-Part of U.S. patent application Ser. No. 11/173,470, filed on Jun. 30, 2005, entitled JOB CATEGORIZATION SYSTEM AND METHOD. This application is also related to United States Patent Application entitled SYSTEM AND METHOD FOR LISTING DATA ACQUISITION, filed concurrently herewith. The disclosures of all previously referenced applications are hereby incorporated by reference in their entirety.

### BACKGROUND

1. Field of the Disclosure

The present disclosure relates to listing services. In particular, it relates to systems and methods of providing listing data administration.

2. General Background

The present structure of the Internet thrives on a web model wherein one World Wide Web (web) site is interconnected to another through a hyperlink. The typical configuration includes a first web page that includes a hyperlink to a second web page. Furthermore, the first and the second web pages are often hosted by different servers. In such cases, when an end user of the first webpage selects the hyperlink to the second webpage, the end user is redirected to the second web page hosted by another web server. Thereafter, the server hosting the first web page loses all interaction with the end user, and furthermore, loses all information regarding actions that the end user performs at the second web page.

One such interlinking is utilized extensively by listing administration providers and listers. Listing administration providers generally provide hyperlinks to webpages hosted by listers. Listings served and maintained by the listing administration provider include listings for the sale of goods or services, classified ads, among others. Typically, upon the listing administration provider acquiring a listing from a lister user, the listing is processed, indexed into a search bank, and published on an Internet website. Listing administration providers are, for example, auction websites listing auctioned items, job databanks listing employment opportunities and openings, real estate listing companies, among others. End users, seeking for specific items, are provided with an easy web search capability that allows them to extract relevant information that addresses their needs.

In addition, listers possess listing information to be conveyed to end users. Thus, for example a lister user may be any entity that sells or leases items, or provides services. Examples of listers include vehicle manufacturers and resellers, homeowners, employers, etc.

Once an end user clicks on a listing at the listing administration provider, the end user is redirected to the lister's website. Typically, the listing administration provider does not receive nor has a way to know of the actions of the end user. For example, the listing administration provider does not know whether the end user that clicked on the listing actually purchased the product, applied for a job, or registered as an end user.

### SUMMARY

In one aspect, in accordance with the present disclosure there is a method of providing listing data administration to a lister user. Listing data corresponding to at least one information item can be acquired. For example, the listing data can comprise job listings or real estate listings. The listing data is posted on a web search bank hosted by a listing administration provider. Furthermore, the listing data is posted with an assigned hyperlink that references a lister user website hosted by a lister user web server. A selection token is transmitted to the lister web server when an end user selects the assigned hyperlink. An action token is received from the lister web server. The action token can include end user activity data that represents actions performed by the end user at the lister website. In addition, the listing data can be acquired from a lister user.

In another aspect of the method, the end user activity data includes data indicative of an end user purchase of a product at the lister website. For example, the end user activity data may include data indicative of an end user applying for a job opening at the lister website.

The selection token includes a lister user identifier and a listing identifier. The action token can also include the lister user identifier and the listing identifier.

In yet another aspect of the method, the lister makes a payment to the listing administration provider for the posting of the listing data. A lister user administration server can report performance of listing data based on one or more action tokens received in association with the listing data.

A system that provides listing data administration capabilities to a lister user is also disclosed. The system can comprise an acquisition server, a listing server, and an action tracking server. In an exemplary embodiment, the acquisition server acquires listing data that can correspond to at least one information item. In addition, the listing data can be acquired from a lister user. The listing server can post the listing data on a web search bank hosted by a listing administration provider. The listing data then posts with an assigned hyperlink that references a lister user website hosted by a lister user web server. In addition, the listing service transmitting a selection token to the lister web server when an end user selects the assigned hyperlink. Moreover, the action tracking server receives an action token from the lister web server. The action token includes end user activity data. The end user activity data represents actions performed by the end user at the lister website.

A method of communication information between a first web server and a second web server is also disclosed. In this method, a hyperlink is provided on a first website hosted at the first web server. The hyperlink can reference a second website hosted at the second web server. An indication that an end user selected the hyperlink referencing the second website can be received at the first web server. A selection token can be transmitted from the first web server to the second web server. The selection token can include a network address of the first web server. An action token can be received from second web server. The action token can be indicative of an action performed by the end user at the second web site. The hyperlink can, for example, reference a job listing data at the second website, or a real estate data at the second website.

The first web server may be a listing server and the second web server may be a lister user server. The end user activity data may include data indicative of an end user purchase of a product at the second website. In another aspect, the end user activity data includes data indicative of an end user applying for a job opening at the second website. The selection token can include a lister user identifier and a hyperlink identifier. The action token can further include the lister user identifier and the hyperlink identifier.

In addition, hyperlink performance can be reported based on one or more action tokens received in association with the hyperlink. One or more reports can be generated at the first web server.

In another aspect according to the present disclosure, a computer readable medium encoding a computer program of instructions for executing a computer process for data acquisition by a listing administration provider is disclosed. The computer process may include multiple steps in which listing data is acquired. The listing data can correspond to at least one information item provided by a lister user. The listing data is posted on a web search bank hosted by a listing administration provider. Furthermore, the listing data is posted with an assigned hyperlink that references a lister user website hosted by a lister user web server. A selection token is transmitted to the lister web server when an end user selects the assigned hyperlink. An action token is received from the lister web server. The action token can include end user activity data that represents actions performed by the end user at the lister website.

### DRAWINGS

By way of example, reference will now be made to the accompanying drawings.

FIG. 1 illustrates a listing data administration system in accordance with the present disclosure.

FIG. 2 illustrates a screen shot of a posting of listing data in accordance with the present disclosure.

FIG. 3A illustrates a selection token data structure in accordance with the present disclosure.

FIG. 3B illustrates an action token data structure with an action field in accordance with the present disclosure.

FIG. 3C illustrates an action token data structure with multiple action fields in accordance with the present disclosure.

FIG. 4A illustrates a selection token with exemplary selection token data in accordance with the present disclosure.

FIG. 4B illustrates an action token with exemplary action token data in accordance with the present disclosure in accordance with the present disclosure.

FIG. 5A illustrates a data flow diagram for a process of tracking user's actions at a lister user computer in accordance with the present disclosure.

FIG. 5B illustrates a data flow diagram for a process of tracking user's actions at a listing administration provider computer in accordance with the present disclosure.

FIG. 6 illustrates an integrated system for data acquisition and administration in accordance with the present disclosure.

FIG. 7 illustrates a screen shot of a listing administration interface in accordance with the present disclosure in accordance with the present disclosure.

FIG. 8 illustrates a screen shot of a listing administration interface for editing a listing in accordance with the present disclosure.

FIG. 9 illustrates a data flow diagram for a process of upgrading the status of a listing in accordance with the present disclosure.

FIG. 10 illustrates internal components of a reporting module in accordance with the present disclosure.

FIG. 11 illustrates a screen shot of a reporting interface in accordance with the present disclosure.

### DETAILED DESCRIPTION

The system and method disclosed herein permits a first web server to obtain information of end user activity at a second web server. In particular, the system and method disclosed allows listing administration providers to obtain information regarding end user activity at websites to which the listing administration provider redirects. Such websites can include listers' websites. Unlike traditional listing systems wherein the listing administration provider disconnects with the end user once the end user is redirected to another site, the system and method provided herein permits an end user to monitor end user activity at a lister's site to which the end user is redirected.

Furthermore, the listing administration provider can utilize the information obtained regarding end user activity to dynamically generate reports. In one embodiment, such reports are based on a specific listing, and can be provided to the lister owning the listing. Therefore, the lister can monitor the performance of ads and other types of listings posted at a website of a listing administration provider, and thereby make a determination of the effectiveness of a given ad or other type of listing. Further, reports to listers can be provided as financial tools that render information such as return on advertisement investment, etc.

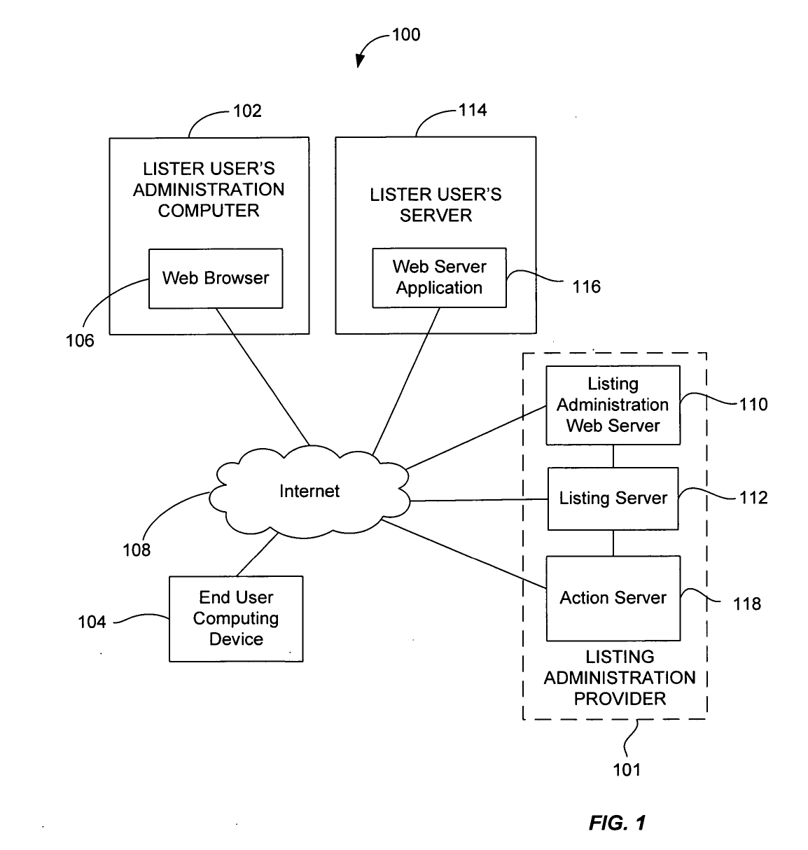

FIG. 1 illustrates a listing data administration system 100 in accordance with the present disclosure. The listing data administration system 100 comprises a lister's administration computer 102 and a listers server 114. In one embodiment, a lister's administration computer 102 and a listers server 114 reside in the same computer housing. In another embodiment, a lister's administration computer 102 and a listers server 114 reside in a separate computer housing. The lister's administration computer 102 can include a web browser 106. The web browser's 106 facilitates how the listers interaction with the Internet with webpages hosted by the listing administration web server 110. In one embodiment, the listing administration web server 110 is maintained by a listing administration provider 101. The listing administration web server 110 allows the lister to interact with the lister administration web server 110 to add, delete, edit and in general administrate the listings that the lister wants to post through the listing administration provider 101. As such, the lister utilizes the web browser 106 at the lister administration computer 102 to access an administration site to manage listings.

As previously mentioned, listers are provided with the opportunity to render accurate listing data to a listing administration provider 101 through the listings administration web server 110. In other embodiment, the listing data is provided by the lister to the listing administration provider 101 by uploading files, providing uniform resource locator sites where listing data is ready for the listing administration provider 101 to collect, etc.

Therefore, the lister administration computer 102 allows a lister user to transmit listing data to a listing service by “pushing” the relevant listing data to the listing administration web server 110. In another embodiment, the data can be pushed to a listing manager (not shown) through the Internet 108. In addition, the lister administration computer 102 allows a lister user to transmit the location of the listing data to a listing service so that the listing service can “pull” the relevant listing data and process the listing data at a listing manager.

The listing administration server 110 can be a computing module that resides in a computer infrastructure of a listing administration provider 101. Alternatively, the listing administration server 110 can be a computing module that resides in a computer infrastructure of a listing administration provider 101. For example, a job listing administration provider 101 can utilize a computer infrastructure to post all available job listings on the Internet 108. The listing administration server 110 can reside in a computer server connected to the Internet 108. The listing data can be acquired by either requesting the data from the web browser 106, scraping the data published on the Internet 108 by the web browser 106, or by simply receiving the listing data submitted by the web browser 106.

In addition, once the listing information is acquired from the lister's administration computer 102, the listing administration web server 110 can provide the listing information to a listing server 112, which in turn publishes, or otherwise makes available, the listing information on the Internet 108. The listing server 112 can be for example, a web server, an ftp server, or any other server configured to post information on the Internet 108 for user viewing and searching.

Once published and listed, the listing data is available for users to view and search the listing data at an end user computing device 104. The end user computing device can be a personal computer, a handheld device, etc. Upon requesting sending a request, the end user computing device 104 receives listing information posted by the listing server 112. In one embodiment, the end user computing device 104 can receive the listing data either based on a request to the listing server 112, wherein the end user computing device 104 includes a web browser and requests listing data from the listing server 112. In another embodiment, the end user computing device 104 receives the listing data based on a transmission by the listing server 112, wherein the transmission is initiated by the listing server 112. In one example, the end user computing device 104 receives a Really Simple Syndication (RSS) feed. In another example, the end user computing device 104 receives a podcast.

The end user can view and access the listing data through a web server at the end user computing device 104. Each listing shown on the web page at the end user computing device 104 can include a hyperlink to each of the listings posted by the listing server 112. For example, if a hyperlink is associated with a listing for job listing for a java language programmer, then the hyperlink can link to a website of a job lister, namely an engineering firm employer. When viewing the listing at the end user computer device 104 the end user can clicks or accesses the hyperlink to be redirected to a web page hosted by the web server application 116 at the listers server 114. The end user can access the web page of the lister, namely the engineering firm. Once at the lister website, the end user can submit a resume or apply for the job by filling out a form hosted by the web server application 116. In one example, the lister's server 114 is a server of the human resources department of an employer, and the web server application 116 hosts a web site for the human resources department and accepts resumes, posts further information on job opportunities, etc.

Once the end user accesses the link or select the hyperlink the listing server 112, in addition to redirecting the end user to the web server application, the listing server 112 can send a selection token to web server application through Internet 108. The selection token can include information regarding the end user, the specific listing that the end user selected, and the time at which the end user selected the listing based on a time stamp.

In one embodiment, tokens are transmitted upon the creation of a listing. Thus, the selection token can be transmitted to the web server application in relation to the activation of a listing to be posted at the listing server 112. If a listing is selected to be active and displayed, then listings that are to be posted are associated with selection tokens that are subsequently sent to web server application 116.

In another embodiment, every time a hyperlink associated with a listing is selected, a selection token is selected and transmitted to the web server application 116. Each of the listing can have an associated token that is sent to the listers server 114 upon the end user clicking or selecting the hyperlink at the webpage posted by the listing server 112.

Once the web server application 116 has a token associated with a particular listing click, the web server application 116 can be configured to further track and monitor end user activity as related to the listing. For example, if the end user selects the java language programmer job listing at user computer device 104, the web server application 116 can detect whether the java programmer applied for the java language programmer job, or whether the end user views further information on the job, or whether the end user selects similar jobs listed at the lister site, etc. In another embodiment, the listing can be for a sale of an item, and the action tracked the end user purchase of the item.

Upon detection of an action, the web server application 116 can send a token through the Internet to the action tracking server 118. Upon receiving the action token from the web server application 116, the action tracking server 118 can categorize and manipulate the action token to accumulate data on the end user that clicked on the hyperlink associated to the listing the demographics, the times at which the actions were taken, the type of actions that the end user took related to the listing. Therefore, once action tracking server 118 can forward the data to anther process for statistical analysis and other factors.

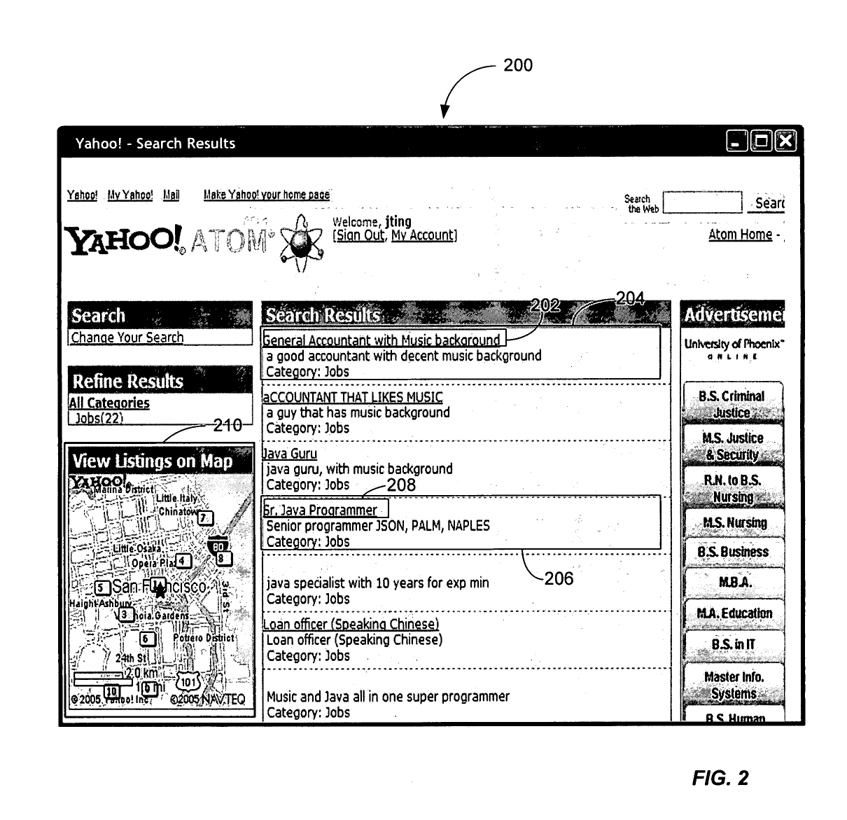

FIG. 2 illustrates a screen shot of a posting of listing data in accordance with the present disclosure. An end user searching through listings posted by the listing administration provider 101 can utilize searching criteria to search in the search banks to receive more narrow and focused results. The screen shot 200 illustrates listings that are the result of a search query operation. In one example, a listing 202 can include the listing title 204 that indicates the title for the listing “General Accountant with Music Background.” In addition, the listing 202 can include any further information provided by the lister. For example, a description of the job listing can be posted as part of the listing. In another example, the category of the listing can also be provided as part of listing 202. Furthermore, listing title 204 can be hyperlinked to a lister user website, a website at the listing administration provider 101 which provides more information, an email link, a download of a job application, or any other action that can be assigned to the hyperlink. Upon the end user selecting the hyperlink at listing title 204, a selection token is transmitted to the website to which the end user is redirected.

In a further example, listing 206 for a job listing can also be provided, wherein the listing title 208 is “Sr. Java Programmer.” Again, the listing title can be hyperlinked to a lister user employment website, etc. Thus, if the position for Sr. Java Programmer was posted by an engineering firm, the hyperlink at the listing title 208 can redirect an end user to a website provided by the engineering firm.

Finally, other forms of posting listings are available for an end user. For example, listings can be posted on a listing map 210. Listing map 210 can include numbers or any other symbols representative of the listing. In the case of job listings, the symbol representing each listing can be positioned at the location of the employer.

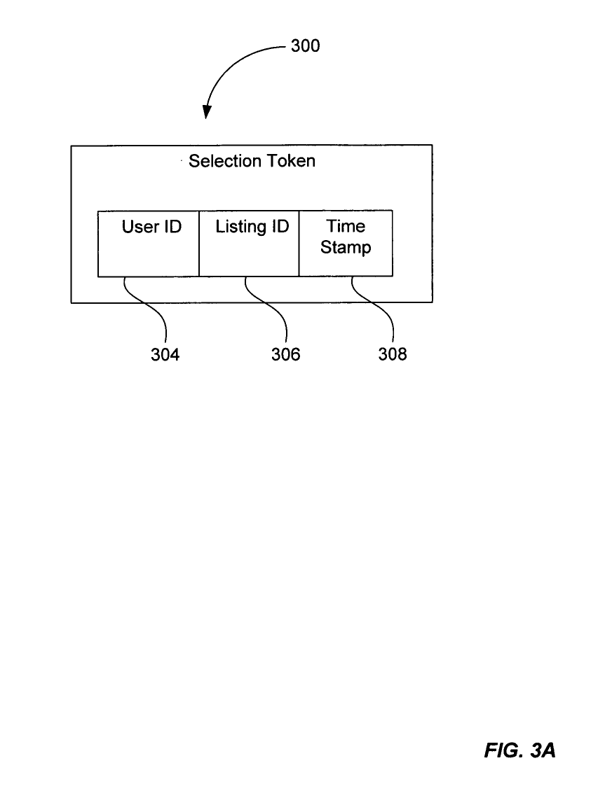

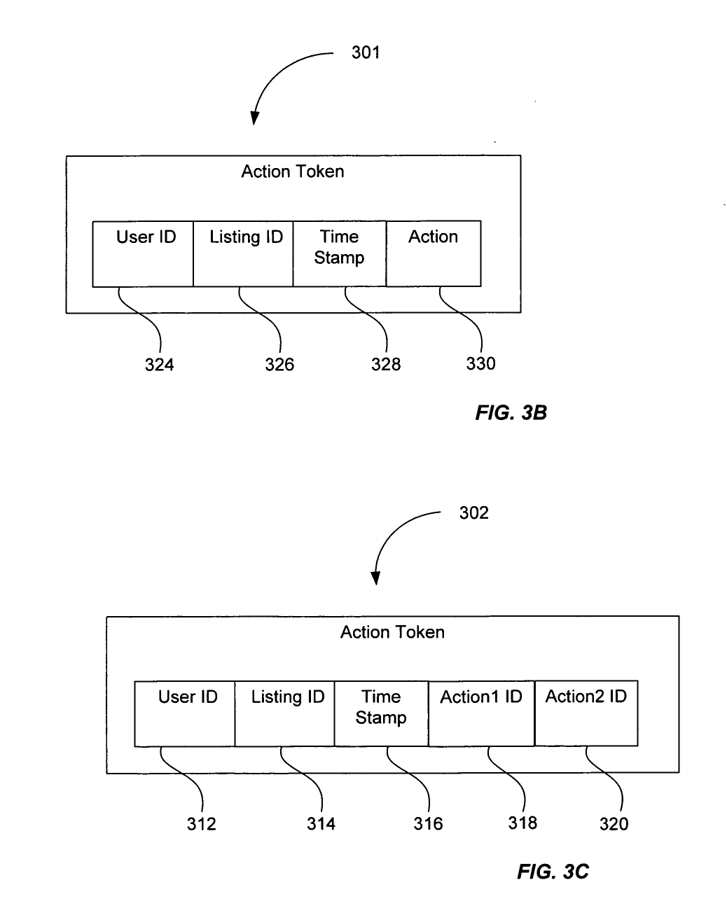

FIG. 3A illustrates a selection token 300 data structure in accordance with the present disclosure. The selection token 300 can refer to the token of information sent from the listing server 112. In another implementation, the selection token 300 can be sent from the action tracking server 118 based on a request from the listing server 112.

The selection token data structure can include data fields for a lister user identifier 304, a listing identifier 306 and a timestamp 308. In one embodiment, the lister user identifier 304 can be an end user profile. In another embodiment, the lister user identifier 304 can be any alphanumeric combination that uniquely identifies an end user viewing the listings at the end user computing device 104. For example, a job seeker that is browsing through listings can be assigned a lister user identifier. In another example, an online shopper that is browsing through items for sale can also be assigned a lister user identifier 304. In yet another example, an end user that is browsing any site and that is presented with an ad on a webpage can be assigned a lister user identifier 304.

The listing administration provider 101 can further allow users to register with the listing administration provider 101 by creating an account. The account can have an associated user account. In one embodiment, the listing administration provider 101 may fill in the token user identifier 304 with the end user account name. In another embodiment, the listing administration provider 101 may create a new identifier associated with the end user in order to preserve the anonymity of the end user when the token is sent over the Internet 108. Based on user-entered information, the end user service provider can associate the selection token with an end user profile.

The selection token 300 can also include a listing identifier 306 that is associated with a specific listing. In one embodiment, the listing identifier 306 is a combination pair of a lister user identifier 306 and a number corresponding to the listing. In another embodiment, the listing identifier 306 includes a sequential number assigned to the listing at the time of creation of the listing regardless of the associated lister. The listing identifier 306 can be included in the selection token 300 so that the lister's server 114 can process action data and any other pertinent data in relation to the specific listing. In addition, the listing identifier 306 can be sent back to the action tracking server 118 for further collection and manipulation of data in relation to the specific listing.

Finally, a timestamp 308 can be included in the selection token 300 so that the time and date when the end user accessed the specific hyperlink associated with the listing can be recorded. Thus, if the same user accesses the same listing twice, the time stamp 308 will permit to differentiate each of the two access attempts because the time stamp 308 will be different for each of them.

The selection token 300 can be implemented by software or hardware configurations. Furthermore, it will be apparent to one skilled in the art that various software data structure paradigms can be utilized such as a list, an array, a queue, a class, among others.

FIG. 3B illustrates an action token data structure with an action field in accordance with the present disclosure. The action token 301 can refer to the token of information received at the listing server 112 as part of reporting that an end user took some action at the lister's server. In another embodiment, the action token 301 can refer to the token information received at the listing server 112 in response to a selection token received at the lister's server. Thus, the lister's server can report every time a selection token is received even when no action was taken so that the listing server 112 can record that no action was taken by the end user. In another implementation, the action token 301 can be received at the action tracking server 118.

The action token 301 can include a lister user identifier 324, a listing identifier 326, a timestamp 328, and an action field 330. In one embodiment, the lister user identifier 324 can include the same information received with the selection token 300. As such, the web server application 116 can copy the lister user identifier information in the lister user identifier 304 of the selection token 300 for populating the information in the lister user identifier 324. In another embodiment, the web server application 116 can further add or change the end user information to specific data that the lister can interpret when reading reports at the listing administration web server 110.

Similarly, the listing identifier 314 can include the same listing identifier information received at the selection token 300. Alternatively, the listing identifier 314 can include further information added or edited by the lister such that the when populated in reports at the listing administration web server 110, the lister can easily interpret.

The timestamp 301 can include the time at which the selection of the hyperlink was made, and therefore includes the same timestamp information received from the selection token 300. In another embodiment, the timestamp 301 can include the time at which a particular action was taken by the end user.

Finally, the action field 330 includes data indicative of an action taken by the end user at the lister's site. In one embodiment, the lister and the listing administration provider 101 agree upon a list of mutually accepted codes that indicate specific actions that can translate to longer descriptions. For example, “100” can be agreed to mean “Viewed Information at the website.” In another embodiment, the lister can include any other symbol or indication that a specific action was taken.

FIG. 3C illustrates an action token data structure with multiple action fields in accordance with the present disclosure. In another embodiment, an action token 302 can have different configurations. The action token 302 can also include similar information as the selection token 300 at the lister user identifier 312, the listing identifier 314, and the timestamp 316. For example, the action token 302 can further include a first action identifier 318 and a second action identifier 320. Each action identifier can correspond to a different action taken by the end user. For example, the first action identifier 318 can contain data regarding an end user visit to the lister site for a predetermined amount of time. The second action identifier 320 can contain data on whether the end user bought a product at the lister's site.

Furthermore, the lister can include other fields in the action token 301 or action token 302. In one example, a second timestamp can be included in the action token data structure, wherein the second timestamp indicates a time at which the action occurred. In another example, the amount of time spent at the lister's site can also be another parameter that is included in the action token 302.

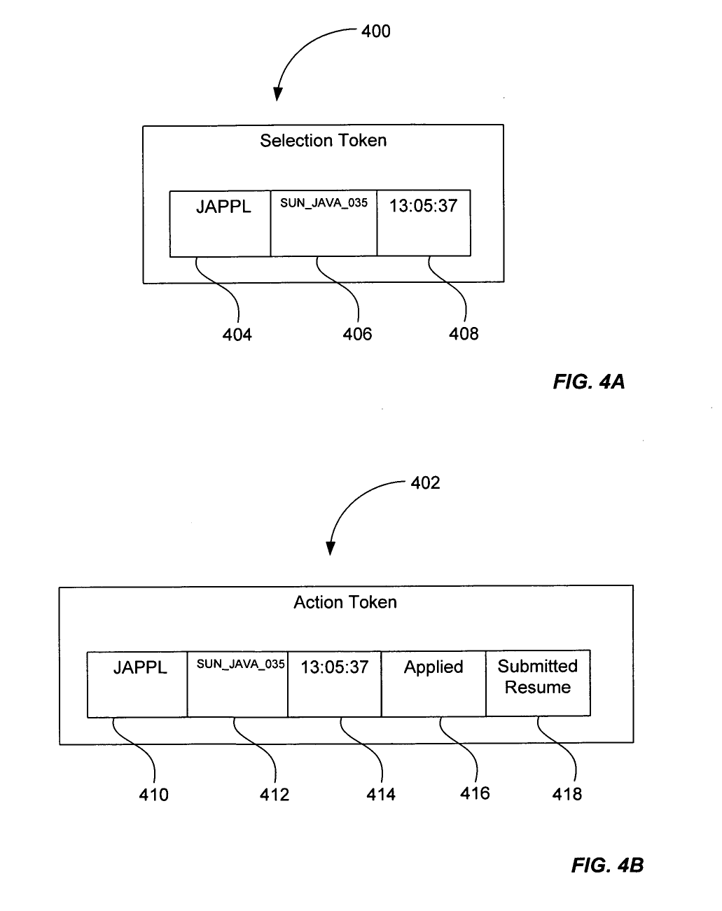

FIG. 4A illustrates a selection token with exemplary selection token data in accordance with the present disclosure. The selection token is sent from the listing server 112 to the web server application 116 upon the end user selecting a job-listing hyperlink at the listing administration provider 101's site. In one example, a selection token 400 can contain a lister user identifier 404 with data “jappl,” a job listing identifier 406 with data “sun_java_{—}035,” and a timestamp 408 with time “13:05:37.” Thus, the selection token 400 contains data related to an end user applying for a job and accessing a job listing for java programming. The job seeker can access the listing at the employer's site by clicking on a hyperlink associated with the job listing. Once the end user clicks on the hyperlink, the selection token 400 is created with the data discussed above. Further data can be provided in the selection token 400. For example, the date can also be indicated in the timestamp 408. In another embodiment, the selection token 400 can include the income received from the sale of an item or a service. In yet another embodiment, the selection token 400 includes the quantity of products purchased from the lister.

The selection token 400 can further include the network address, or other indication of origin, of the listing server 112. The network address information can later be used by the lister server 114 for routing information to the listing server 112, such as other tokens, acknowledgements, etc.

In addition, the lister user identifier 404 and the job listing identifier 406 can be encrypted for added security. Alternatively, other security mechanisms can be used to transmit the token from the listing administration provider 101 to the lister.

FIG. 4B illustrates an action token with exemplary action token data in accordance with the present disclosure. The selection token is sent from web server application 116 to the action tracking server 118 upon the end user taking an action at a website provided by the lister's server 114. The action token 402 can include one or more action fields. In one embodiment, the action token 402 includes action field 416 which includes data that indicates that the end user has applied for the job at the lister's site. In addition, action field 418 includes data that indicates that the end user has submitted a resume 418.

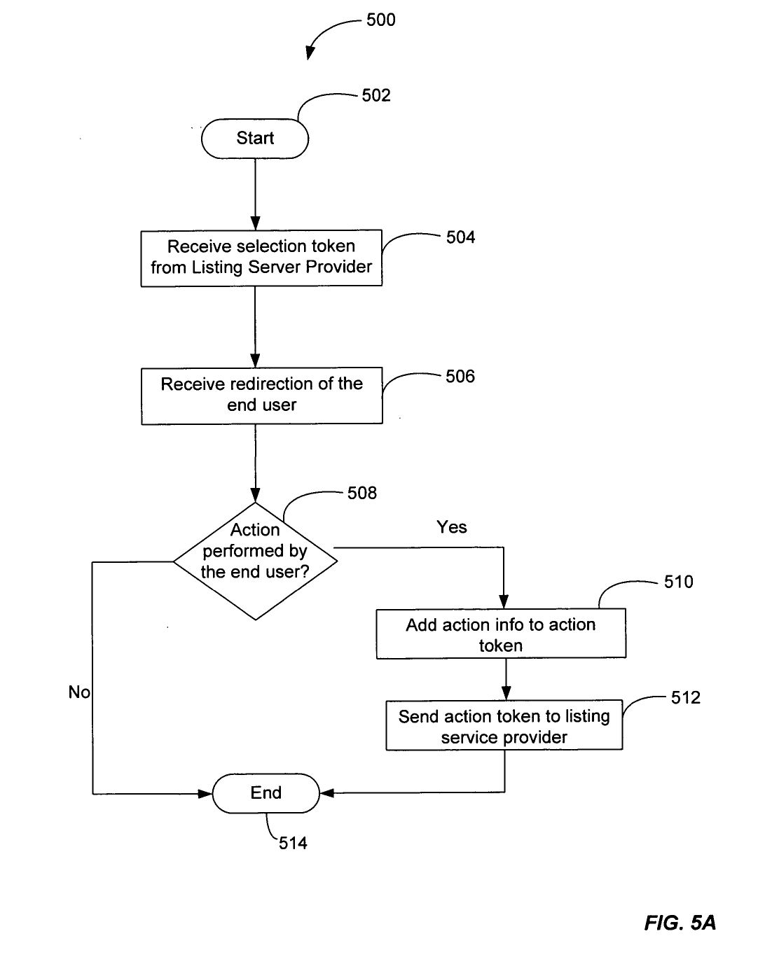

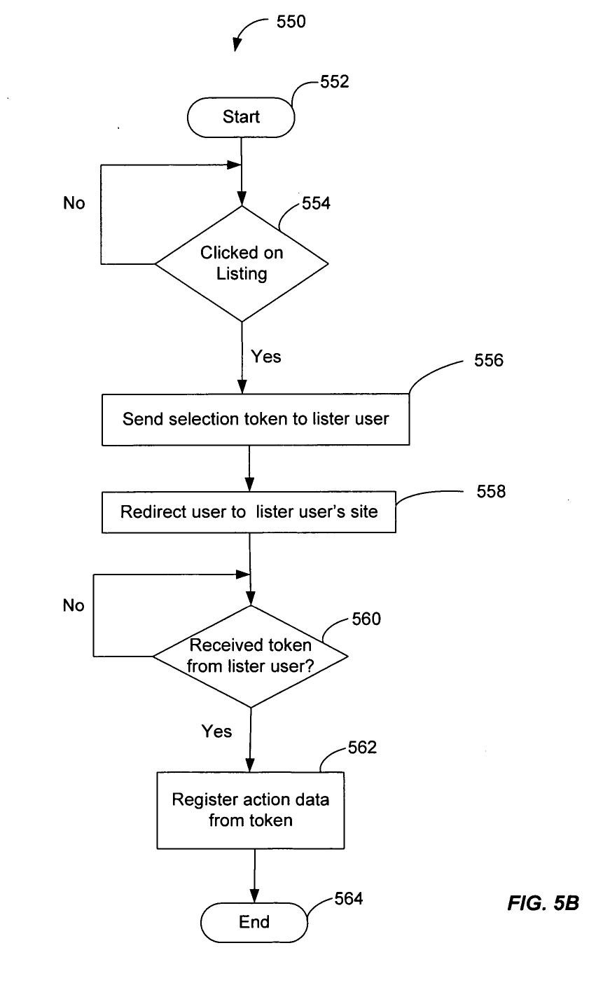

FIG. 5A illustrates a data flow diagram for a process 500 of tracking user's actions at a lister user computer in accordance with the present disclosure. The process starts at start block 502. At process block 504, a selection token is received from the listing administration provider 101. As mentioned above, the lister can receive the selection token from the listing server 112 upon an end user selecting a hyperlink associated with a listing. The lister can receive the selection token at the web server application 116. Next, at process block 506, the web server application 116 receives a request for a webpage from the end user computing device 104. For example, the request can be made by a web browser at the end user computing device 104.

At decision block 508, a determination is made as to whether the end user took a predetermined action. The web server application 116 can include logic to determine the actions tracked, and consequently, determine the actions reported to the listing administration provider 101. For example, if the listings are for job listings, the lister (e.g. an employer) can define actions to be reported to back to the listing administration provider 101 (e.g. job listing service). Predetermined actions can be, for example, applying for the job associated with the job listing. In another example, if the listing is an ad for a product, the predetermined action can be, for example, the end user buying or leasing the product.

If it is determined that the end user took a predetermined action, then the web server application 116 packages the action token at process block 510. Then, at process block 512, the token is sent to the listing administration provider 101 at the action tracking server 118. If the end user does not perform an action, the process ends at process block 514. In one embodiment, the web server application 116 makes the determination of whether the end user has not taken an action can be made after a predetermined amount of time.

FIG. 5B illustrates a data flow diagram for a process 550 of tracking user's actions at a listing administration provider 101 computer in accordance with the present disclosure. The process 550 starts at process block 552. At decision block 554, a determination is made as to whether a listing has been selected by an end user viewing listings hosted by the listing server 112. In one embodiment, the listing server 112 can check whether a given listing has been selected or clicked on. If the listing has been selected by the end user, the process 550 proceeds to process block 556. In one embodiment, if the end user does not click or select the listing, the process 550 continues to check until the end user selects a listing.

At process block 556, a selection token is sent to the lister. For example, the selection token can be sent to the web server application 116. Next, at process block 558, the end user is redirected to the lister's website. In one example, the end user is redirected to a website hosted by the web server application 116, at the lister's server 114. The process continues to decision block 560. At decision block 560, a determination is made as to whether a token has been received from the web server application 116. In one example, the action tracking server 118 is on idle indefinitely until an action token is received from the web server application 116. Upon receiving the action token, the process continues to process block 562. At process 562, the data received from the action token is recorded for further processing, analysis, and posting.

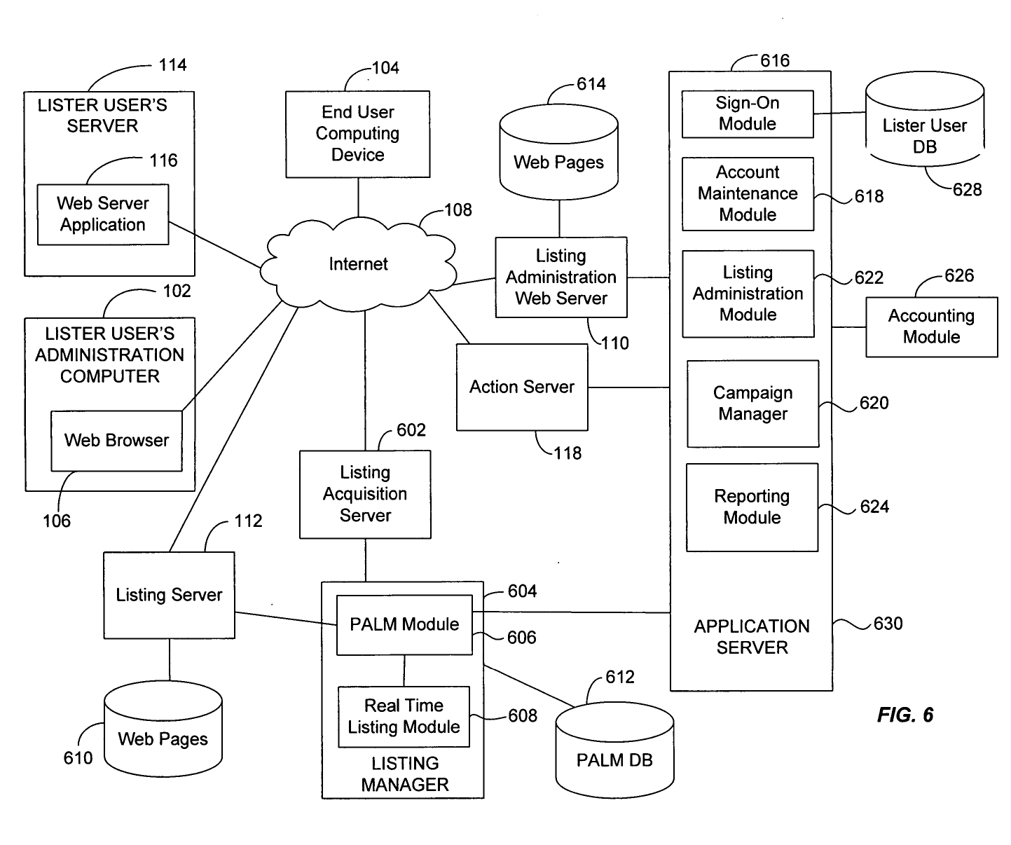

FIG. 6 illustrates an integrated system for data acquisition and administration in accordance with the present disclosure. The system includes a data acquisition server 602 that allows a lister user to submit listing data to a listing administration provider 101. The data acquisition server 602 can interact with a listing manager 604 that categorizes, filters, cleanses, and in generally maintains the listings located at a PALM database 612. In one embodiment, the listing manager utilizes a PALM module 606 to process submitted or acquired listing information. The PALM module 602 and functionalities are described in detail in the U.S. patent application Ser. No. 11/174,393, filed Jun. 30, 2005, and entitled System and Method for Managing Listings, assigned to the assignee of the present application.

In addition, the listing manager 604 can include a real time listing module 608 the permits the immediate posting of recently acquired listings at the listing server 112. In one embodiment, the listing server 112 can access a webpages database 610 that stores data for providing listing webpages.

In another embodiment, an application server 630 can be communicated with a listing administration web server 110 and the action tracking server 118. The application server 630 may include modules for administrating listings associated with a lister user. A sign-on module 616 that interacts with an end user database 628 includes logic to permit a lister user to sign-in and gain access to administrative privileges. The application server 630 can further interact with an accounting module 626 that tracks financial gains and other monetary aspects related to the account of the lister. In addition, multiple operational modules can be provided in the application server 630 to allow an end user to administrate listings, track performance and return on investment, set-up campaigns, etc.

In one embodiment, the application server 630 includes an account maintenance module 618, a listing administration module 620, a campaign manager 622, and a reporting module 624. The account maintenance module 618 can provide the lister with an interface for viewing, paying or inquiring the latest billing, profile maintenance, set-up multiple accounts, etc.

The listing administration module 620 permits a lister user to add, delete, or edit listings. The campaign manager 622 can permit a lister user to set-up campaigns for a listing or a group of listings. Finally, the reporting module 624 permits a lister user view the performance of listings, demographics and statistical analysis on how the listings are used, accessed, and treated by users.

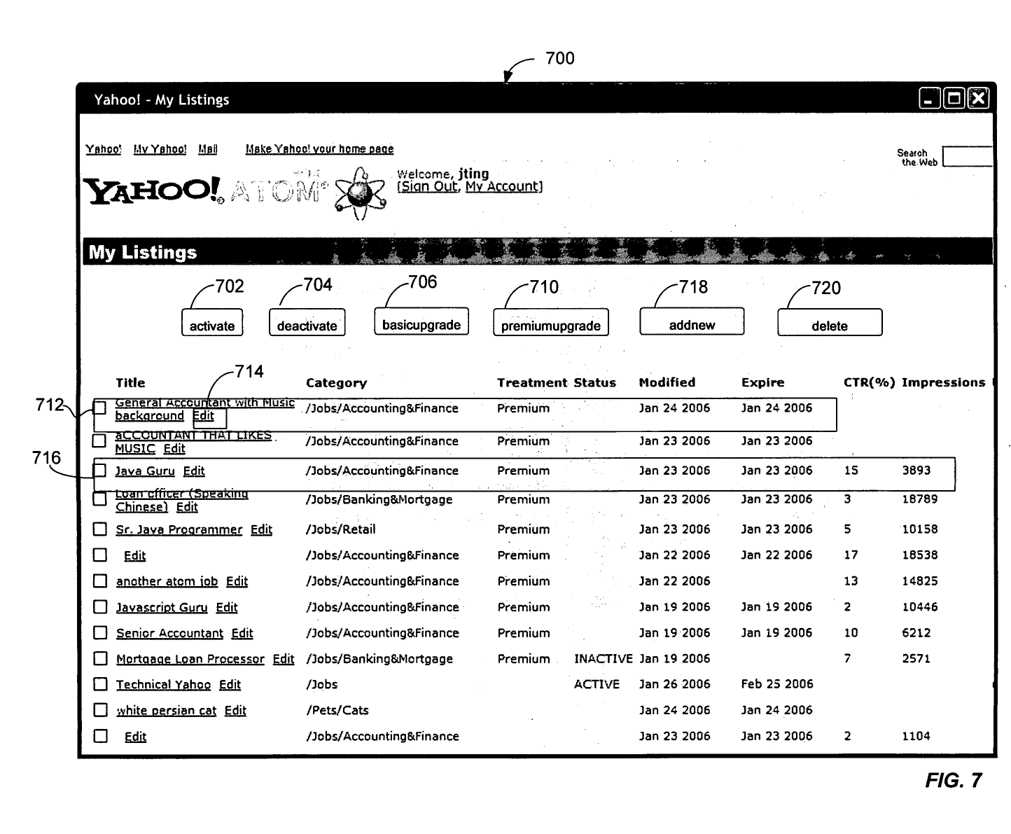

FIG. 7 illustrates a screen shot of a listing administration interface 700 in accordance with the present disclosure. The listing administration module 622 can be configured with logic to provide a listed with administration capabilities on the listings of the lister. For example, the listing administration interface 700 can provide a list of all of the listings that the lister can administer.

In another embodiment, the listing administration interface 700 can further provide an activate function. The activate function permits a lister user to select and activate one or more listings for posting by the listing server 112. In contrast, the listing administration interface 700 can also provide a deactivate function that permits a lister user to select and deactivate one or more listings in the activated state such that the selected listings are no longer posted by the listing server 112. Therefore, a lister user can select which listings are posted on the listing server 112 of the listing administration provider 101.

In another embodiment, the listing administration interface 700 can provide a basic upgrade function. The listing administration provider 101 can provide free posting of the each listing that the lister administrates and makes active. Furthermore, the basic upgrade function can provide a lister user with the opportunity to convert one or more listings to paid listings. That is, the lister can upgrade the manner in which the listing is posted by making one or more payments associated with the listing.

The amount of the associated payment may vary according to the basic upgrade provided for the listing. Basic upgrade features may include posting frequency, font, color, size of the text of the listing, visibility of the listing. Furthermore, end user actions related to the listing can be tracked as part of the basic upgrade. In addition, the basic upgrade can allow a lister user to receive one or more reports of the performance of the listing.

In yet another embodiment, the listing administration interface 700 can also provide a premium upgrade function. The premium upgrade can further provide with additional enhancements to the manner of posting, tracking, and performance reporting. As such, a lister user who is an employer of engineers, and has active listings for java programmers, can upgrade a listing for a java programming job such that the listing has greater visibility, and further includes a hyperlink to a map where the employer is located. In another example, a lister user who is a retailer of televisions can request a premium upgrade for all the flat panel display televisions listings such that an image is also displayed with the listing. In addition, the lister retailer can request tracking of a consumer's actions once the consumer is redirected to the retailer's website. A specific action to be tracked can be requested, such as whether the consumer made a purchase of a flat panel display television.

As illustrated in FIG. 7, an employer lister can interact at a listing administration interface 700. In one embodiment, the activate function is provided through a button 702, the deactivate function is provided through a button 704, a basic upgrade function is provided through a button 706 and a premium upgrade function is provided through a button 710.

In another example, a listing 712 can be one of the listings being administrated by the lister. In further example, a listing 716 can another listing being administered by the lister. Listing 716 can be a job listing for a java programmer. The lister can select that the treatment of the listing be premium. The parameters of premium treatment may be defined by the lister or by the listing administration provider 101. For example, the listing administration provider 101 can establish that all listings with premium treatment be tracked at the lister's website and reported if a job seeker applies for the job.

In addition, listings can include a click-through rating and an impression count. For example, listing 716 can have an associated click-through rate of fifteen percent and an impressions count of three-thousand eight hundred and ninety three.

In a further embodiment, the listing administration interface 700 can also provide an add function and a delete function. An add listing button 718 can be provided in the listing administration interface 700 for adding a new listing. In one embodiment, the lister can utilize the add function to feed new listings to the listing administration provider 101. In another embodiment, the lister utilizes the add function to provide a uniform resource locator to the listing administration provider 101 such that a web crawler process can be used to collect the listing data provided by the lister. Furthermore, a delete button 720 can be provided at the listing administration interface 700. A lister user can remove a listing permanently through the delete function.

In addition, the listing administration interface 700 can also provide with an editing function. In one example, listing 712, which is a job listing for general accountant, can include an edit function that can be performed by selecting hyperlink 714. Alternatively, the editing function can be provided through a button, or any other interface mechanism.

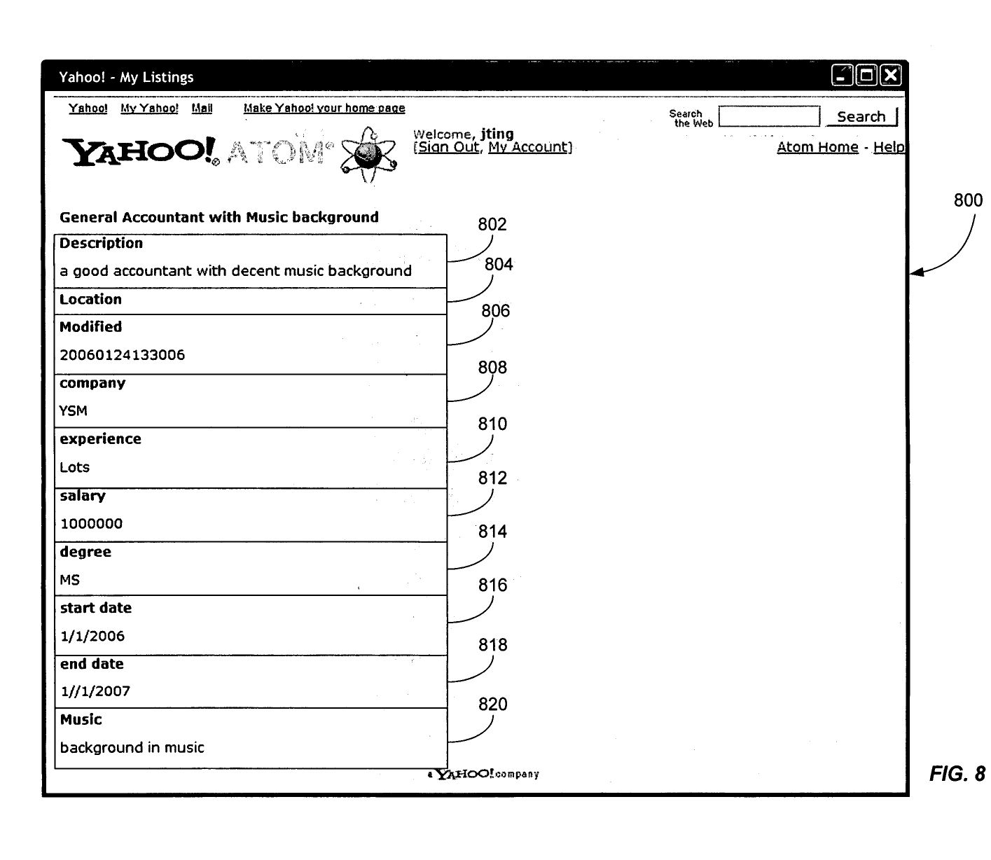

FIG. 8 illustrates a screen shot of a listing administration interface for editing a listing in accordance with the present disclosure. Therefore, once the hyperlink 714 is selected in the listing administration interface 700, the lister is provided with an editing interface 800. The editing interface 800 can include fields for editing various attributes of the listing. For example, the lister can edit the attributes of listing 712 which is a job listing for a general accountant position. The editing interface 800 can include a description field 802, a location field 804, a modified filed 806, a company field 808, an experience field 810, a salary field 812, a degree field 814, a start date field 816, an end date field 818, and a music field 820. Each of the fields can be editable or non-editable. In addition, additional listing attributes can be added by the lister. For example, the music filed attribute 820 is added by the lister as a customized listing attribute for the job listing for a general accountant position.

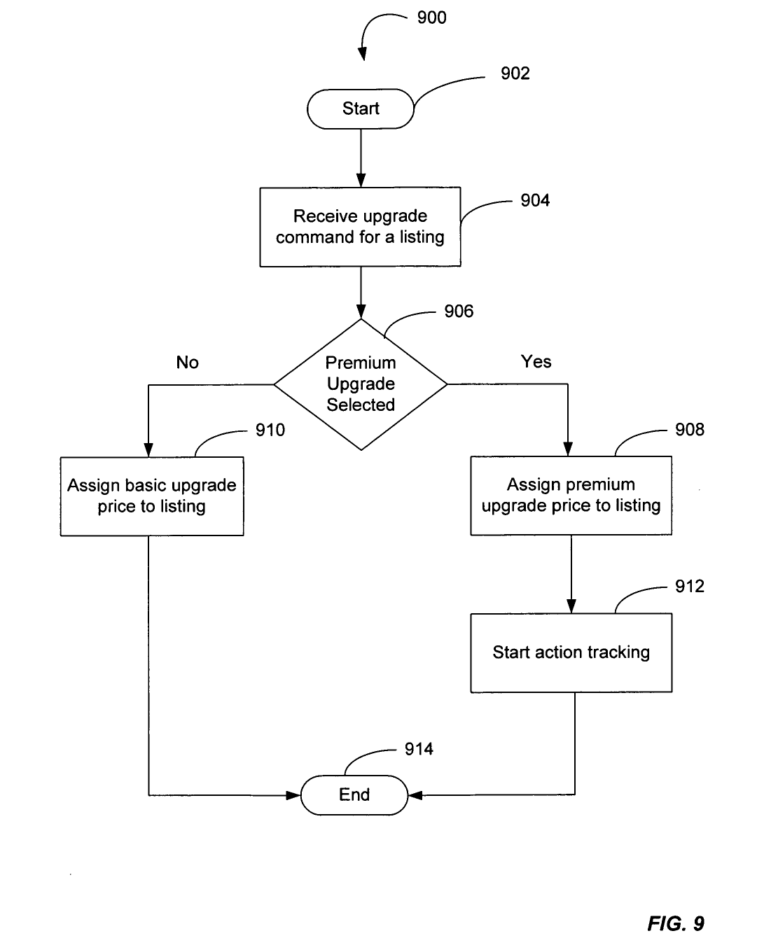

FIG. 9 illustrates a data flow diagram for a process of upgrading the status of a listing in accordance with the present disclosure. Process 900 is exemplary of a premium upgrade of a listing. The process 900 starts at process block 902. At process block 904, an upgrade command is received for a listing. The upgrade command can be received, for example, through the listing administration interface 700. The upgrade command received can be for a premium upgrade or a basic upgrade. Next, at decision block 906, a determination is made as to whether a premium upgrade was selected. If the premium upgrade is not selected at decision block 906, a basic upgrade is assumed, and a basic upgrade price is assigned to the listing at process block 910, and the process 900 ends at process block 914. If the premium upgrade is selected, a premium upgrade price can be assigned to the listing at process block 908. In addition, the process 900 continues to process block 912 where action tracking is initiated for the listing. Therefore, the lister can monitor the performance of the listing based on the actions performed by the users. Next, the process 900 ends at process block 914.

In the exemplary embodiment illustrated by process 900, action tracking is only performed at the premium level. In another embodiment, action tracking of varying complexity can be performed at the basic upgrade level and at the premium upgrade level. In yet another embodiment, more than two levels of upgrading are available such that action tracking at each level varies in detail of actions tracked as well as the methods of reporting. After process 900 ends at process block 914, a subsequent process can be performed, which could be process 900 again.

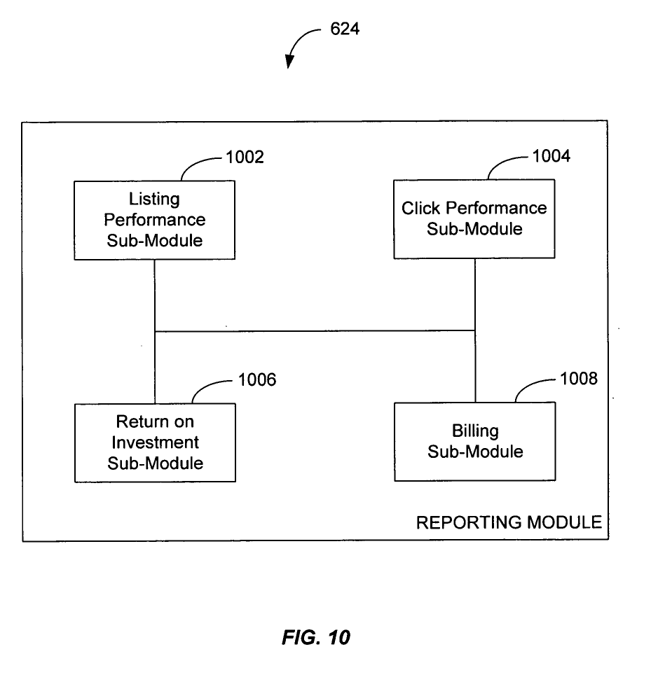

FIG. 10 illustrates internal components of a reporting module in accordance with the present disclosure. The reporting module 624 utilizes data such as total amount of money spent by the lister, amount of money spent per listing, etc. In addition, the reporting module 624 utilizes data contained in action tokens received from the lister's server 114. Data received from the lister's server 114 include actions performed by an end user in association with a given listing. Furthermore, the reporting module 624 can utilize any other data contained in the action tokens such as demographics on users that accessed a specific listing, listing identifiers, times and dates of access to a listing, etc. The reporting module 624 can generate reports based the actions performed by an end user at the lister's site. For example, the reporting module can generate the income generated by each listing, the income generated by a campaign, etc.

The reporting module 624 can include sub-modules that provide reporting functionality based on criteria set by the lister or by the listing administration provider 101. For example, a listing performance sub-module can be configured with logic to analyze data to generate meaningful results.

In one example, a listing can be an advertisement for telecommunication services. The lister, in this example the telecommunications service provider, can administrate the listings through a listing administration web server 110. One of the listings can include an advertisement for cellular service. The telecommunication service provider can further upgrade the treatment of the advertisement such that the listing administration provider 101 tracks the customer actions in association with the advertisement. Thus, for example, the customer visits the listing administration provider 101 website, and clicks on the advertisement of the telecommunications service provider. Every time a that the advertisement is clicked a selection token is sent to the listing administration provider 101, which in turn relays back an action token if the customer purchased the service. Action tokens received from the telecommunication provider include the customer information, the listing data information, timestamps, and the actions performed by the customer at the telecommunication provider's site. Therefore, the data from the action tokens can be processed to analyze purchasing trends and patterns, etc. For example, the data received from action tokens can reveal that five out of ten times a customer is redirected to the telecommunications provider's site, a customer purchases the service. Further, information regarding customer can reveal that four or of the five customers that purchased the product are male. The reporting module 624 can provide a graph or other reporting statistical data showing this pattern. In addition, if for example, the four our of the five customers that did not purchase the product are female, the listing administration provider 101 can provide a further analysis report to indicate the percentage of males, and females that purchase the product. Based of the reported statistics the telecommunications provider can make a decision on launching a campaign targeting the female population, etc.

Each lister can customize the generated reports. Other example includes reports for job listings, wherein the reports generated include the percentage of job seekers that applied at the employer's site. In addition, further statistical data on demographics of the job seekers that applied for the job can also be aggregated and generated.

In another embodiment, a click performance sub-module 1104 can provide reports on the percentage of users who clicked on a given listing. Furthermore, reports on associated user age, gender, preferences, shopping habits can be reported in connection with the users who clicked and those who did not click on a given listing.

In yet another embodiment, a return on investment sub-module 1106 can generate reports indicative of the return on investment on a given listing, a campaign, a product, an advertisement, etc. For example, if a report can indicate a lister user that the monthly average expense on an advertisement for a line of shoes is two thousand dollars. In addition, the report can also indicate the number of customers that purchased the shoes from clicking on the shoe advertisement, the revenues generated from the sale of each pair of shoes, and total revenues generated from the sale of shoes monthly. If for example the monthly revenues from the sale of the shoes are five thousand dollars, the lister retailer can easily verify that the advertisement expenses are well justified.

In another embodiment, a billing sub-module 1108 can provide a lister user with a report on monthly billings, a breakdown per listing, product, campaign, service, etc. Other sub-modules can be provided within the reporting module.

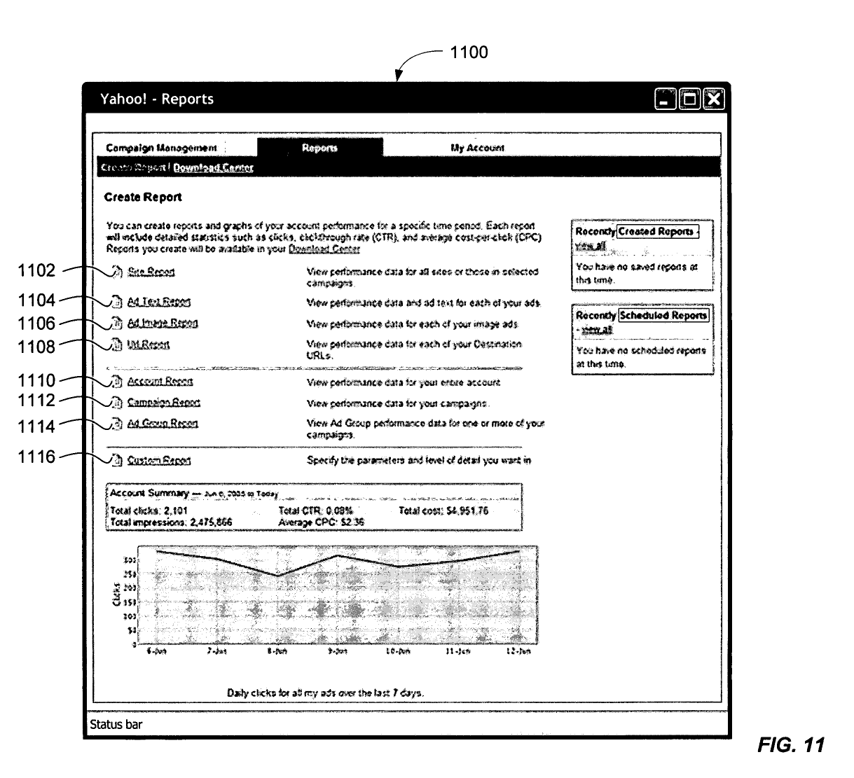

FIG. 11 illustrates a screen shot of a reporting interface in accordance with the present disclosure. Reports can be generated for viewing at a reporting interface 1100. The reports can be provided in the form of pie charts, curves, regression lines, etc. Each report can be customized to reflect a specific time period, product line, user demographics, click-through rates, average cost-per-click, number of clicks on a listing, etc.

For example, in the reporting interface 110, a site report 1202, the lister can customize performance reports for a given web site managed by the lister. A text report 1204 can provide reports based on all text listings. An image report 1206 can provide reports based on all image listings. A URL report 1208 can provide reports based on a destination universal resource locators at the lister's server 114. In addition, an account report 1210 for a report on the performance of the account can be available to the lister. A campaign report 1212 based the performance of each of the campaigns of the lister can be generated. As stated previously, a lister user can customize reports to assess effectiveness of a listing, view dynamically updated performance of a listing, see categorized reporting, etc. The data generated by action tracking of the listings can be utilized to generate reports that allow a lister user to monitor and adjust the listings, delete some listings, add similar listings, upgrade for tracking, etc.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only. For instance, listing data can be related to listings for the sale or lease or various goods and services. Examples of listing data can include sale or lease of goods such as antiques, collectibles, bikes, boats, books, magazines, clothing, accessories, shoes, computers, electronics, cameras, furniture, related to health care, related to personal care, items for the home, items for the garden, jewelry, watches, movies, music recordings, office items, pet supplies, sports and outdoors items, toys and baby items, video games.

Listing data can also be related to goods and service listings related to automobiles, such as used cars, new cars, certified pre-owned, research services, blue book pricing services, parts and accessories, machinery, tools, etc. Listing data can also be related to pets, such as cats, dogs, horses, birds, and related pet services.

Listing data can also be related to housing services, such as homes for sale, rentals, roommates, find a realtor, today's mortgage rates, find a mover, credit reports. In addition, listing data can be related to tickets for events or traveling such as sports concerts, theater, Broadway, traveling destinations, hotels, airfares, etc.

Listing data can be related to employment such as search jobs, posting a resume, creating job alerts, get career advice, searching by job category, etc. Employment related listing data can also be used in HotJobs as provided by Yahoo Inc.

Listing data can also be listing for services. Listing for wanted services, health care, personal care, computer services, creative, erotic, financial, legal, automotive, lessons, household, moving services, construction services, skilled trade, real estate, therapeutic, etc.

Listing data can also be related to personals ads such as platonic or casual encounters, women seeking women, women seeking men, men seeking women, men seeking men, romantic dinners or dates.

In addition, listings can be presented in the form of banners, images, symbols, etc. Listing can also be hyperlinked to an Internet address. Listings can be presented as symbols, or areas in a map, etc. Furthermore, listing administration provider is any entity having a web site in which a lister user can include a listing, such as an advertisement, so that users visiting the web site of the listing administration provider can select the advertisement and redirected to the lister's web site.

As utilized herein, modules can be separate logical computer processes, separate hardware components, standalone computing devices, etc. Any web interface as provided herein can also be a computer application interface that does not interpret mark-up language but rather communicates directly in order to interface with a server computer.

Furthermore, it will also be apparent to one skilled in the art that the any computer network such as a LAN, WAN, wireless network, etc., can be utilized to implement data acquisition. Accordingly, it is intended that the art disclosed shall be limited only to the extent required by-the appended claims and the rules and principles of applicable law. All patents, patent applications and printed publications referred to here are hereby incorporated by reference in their entirety.

1. A method of providing listing data administration to a lister user, comprising:
acquiring listing data corresponding to at least one information item;
posting the listing data on a web search bank hosted by a listing administration provider, wherein the listing data is posted with an assigned hyperlink that references a lister user website hosted by a lister user web server;
transmitting a selection token to the lister web server when an end user selects the assigned hyperlink; and
receiving an action token from the lister web server, the action token including end user activity data, wherein the end user activity data represents actions performed by the end user at the lister website.

2. The method of claim 1, wherein the listing data is acquired from a lister user.

3. The method of claim 1, wherein the at least one information item corresponds to a lister user.

4. The method of claim 1, wherein the end user activity data includes data indicative of an end user purchase of a product at the lister website.

5. The method of claim 1, wherein the end user activity data includes data indicative of an end user applying for a job opening at the lister website.

6. The method of claim 1, wherein the selection token includes a lister user identifier and a listing identifier.

7. The method of claim 6, wherein the action token further includes the lister user identifier and the listing identifier.

8. The method of claim 1, wherein the lister makes a payment to the listing administration provider for the posting of the listing data.

9. The method of claim 1, wherein the listing data comprises job listings.

10. The method of claim 1, wherein the listing data comprises real estate listings.

11. The method of claim 1, further comprising reporting, at a lister user administration server, performance of listing data based on one or more action tokens received in association with the listing data.

12. A system that provides listing data administration capabilities to a lister user, comprising:
an acquisition server for acquiring listing data, the listing data corresponding to at least one information item;
a listing server for posting the listing data on a web search bank hosted by a listing administration provider, wherein the listing data is posted with an assigned hyperlink that references a lister user website hosted by a lister user web server, the listing service transmitting a selection token to the lister web server when an end user selects the assigned hyperlink; and
an action tracking server that receives an action token from the lister web server, the action token including end user activity data, wherein the end user activity data represents actions performed by the end user at the lister website.

13. The system of claim 12, wherein the acquisition server acquires listing data from a lister user.

14. The system of claim 12, wherein the at least one information item corresponds to a lister user.

15. The system of claim 12, wherein the end user activity data includes data indicative of an end user purchase of a product at the lister website.

16. The system of claim 12, wherein the end user activity data includes data indicative of an end user applying for a job opening at the lister website.

17. The system of claim 12, wherein the selection token includes a lister user identifier and a listing identifier.

18. The system of claim 14, wherein the action token further includes the lister user identifier and the listing identifier.

19. The system of claim 12, wherein the lister makes a payment to the listing administration provider for the posting of the listing data.

20. The system of claim 12, wherein the listing data comprises job listings.

21. The system of claim 12, wherein the listing data comprises real estate listings.

22. The system of claim 12, further comprising a lister user administration server that reports performance of listing data based on one or more action tokens received in association with the listing data.

23. A method of communication information between a first web server and a second web server, comprising:
providing a hyperlink on a first website hosted at the first web server, the hyperlink referencing a second website hosted at the second web server;
receiving, at the first web server, an indication that an end user selected the hyperlink referencing the second website;
transmitting a selection token from the first web server to the second web server, the selection token including a network address of the first web server; and
receiving an action token from second web server, the action token indicative of an action performed by the end user at the second web site.

24. The method of claim 23, wherein the first web server is a listing server and the second web server is a lister user server.

25. The method of claim 23, wherein the end user activity data includes data indicative of an end user purchase of a product at the second website.

26. The method of claim 23, wherein the end user activity data includes data indicative of an end user applying for a job opening at the second website.

27. The method of claim 23, wherein the selection token includes a lister user identifier and a hyperlink identifier.

28. The method of claim 28, wherein the action token further includes the lister user identifier and the hyperlink identifier.

29. The method of claim 23, wherein the hyperlink references job listing data at the second website.

30. The method of claim 23, wherein the hyperlink references real estate data at the second website.

31. The method of claim 23, further comprising reporting, at the first web server, hyperlink performance based on one or more action tokens received in association with the hyperlink.

32. A computer readable medium encoding a computer program of instructions for executing a computer process for data acquisition by a listing administration provider, the computer process comprising:
acquiring listing data corresponding to at least one information item;
posting the listing data on a web search bank hosted by a listing administration provider, wherein the listing data is posted with an assigned hyperlink that references a lister user website hosted by a lister user web server;
transmitting a selection token to the lister web server when an end user selects the assigned hyperlink; and
receiving an action token from the lister web server, the action token including end user activity data, wherein the end user activity data to represents actions performed by the end user at the lister website.

33. The computer readable medium of claim 32, wherein the listing data is acquired from a lister user.

34. The computer readable medium of claim 32, wherein the at least one information item corresponds to a lister user.

35. The computer readable medium of claim 32, wherein the end user activity data includes data indicative of an end user purchase of a product at the lister website.

36. The computer readable medium of claim 32, wherein the end user activity data includes data indicative of an end user applying for a job opening at the lister website.

37. The computer readable medium of claim 32, wherein the selection token includes a lister user identifier and a listing identifier.

38. The computer readable medium of claim 37, wherein the action token further includes the lister user identifier and the listing identifier.

39. The computer readable medium of claim 32, wherein the lister makes a payment to the listing administration provider for the posting of the listing data.

40. The computer readable medium of claim 32, wherein the listing data comprises job listings.

41. The computer readable medium of claim 32, wherein the listing data comprises real estate listings.

42. The computer readable medium of claim 32, further comprising reporting, at a lister user administration server, performance of listing data based on one or more action tokens received in association with the listing data.
